(19) United States
(12) Patent Application Publication
(10) Pub. No.: US 2009/0139650 A1
(43) Pub. Date: Jun. 4, 2009

(54) REVERSE OSMOSIS MEMBRANE AND MEMBRANE STACK ASSEMBLY

(75) Inventors: Canan Uslu Hardwicke, Simpsonville, SC (US); Aaron John Avagliano, Houston, TX (US); Gregory Robert Chambers, Clifton Park, NY (US); Stephen Francis Rutkowski, Duanesburg, NY (US); Edward Joseph Hall, Fairview, PA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/333,779

(22) Filed: Dec. 12, 2008

Related U.S. Application Data
(63) Continuation-in-part of application No. 11/263,167, filed on Oct. 31, 2005.

(51) Int. Cl. B01D 67/00; B01D 61/02; C23C 4/12; B05D 5/00

(52) U.S. Cl. 156/278; 427/244; 427/448; 427/596; 427/569

(57) ABSTRACT

A method is provided for making a reverse osmosis membrane comprising flow modifier structures on one or more of its surfaces. The surface modifier structures are disposed on the membrane surface using a direct-write technique. In one embodiment, the present invention provides a method of making a reverse osmosis membrane, the method comprising providing a first membrane layer having an active surface and disposing on the active surface one or more flow modifier structures suing a direct-write technique. In an alternate embodiment, the present invention provides a method for making a polyethersulfone membrane comprising surface structures created using a direct-write technique. In yet another embodiment, the present invention provides a method for making a membrane stack assembly comprising a membrane layer and a feed carrier layer wherein a direct-write technique is used to create surface structures (flow modifier structures) on each of the membrane layer and the feed carrier layer.

### CROSS REFERENCE TO RELATED APPLICATIONS

This application is a continuation in part of U.S. patent application Ser. No. 11/263,167 filed Oct. 31, 2005.

### BACKGROUND

The invention relates to methods of making reverse osmosis membranes. The reverse osmosis membranes provided by the method of the present invention are useful in spiral-wound type membrane separation devices. In addition the present invention provides methods and techniques for making membrane stack assemblies also useful in the preparation of spiral-wound type membrane separation devices.

Spiral-wound membrane elements for reverse osmosis applications have long been regarded as efficient mechanisms for separating components of fluid mixtures. Typically, a pressurized fluid mixture is brought into contact with a membrane surface and a pressure differential is applied to the membrane to cause the fluid mixture to be transmitted through the membrane. One or more components of the fluid mixture pass through the membrane owing to a difference in chemical potential of the component in the fluid mixture before the fluid mixture enters the membrane and after it comes out through the membrane. Owing to varying mass transport rates of various components of the fluid mixture before the mixture enters the membrane and after it comes out through the membrane, separation of the components is achieved.

Known spiral-wound membrane systems use feed spacers with constant channel geometry in an open fabric structure. The constant channel geometry provides convective flow to the fluid mixture, which results in a pressure drop that varies with the cross-flow velocity of the feed solution. Conversion efficiency of known spiral-wound membrane systems as described by the ratio of the flow rate with permeate pressure loss to the flow rate without permeate pressure loss may be increased if the boundary layer formed by the surface liquid is broken.

The methods provided by the present invention are useful in the preparation of membrane layers, reverse osmosis membranes, and membrane stack assemblies comprising surface structures on the membrane surface, which hold potential to enhance the performance of devices relying on membrane layers to effect separation of various feed solutions into permeate and concentrate components.

### BRIEF DESCRIPTION OF THE DRAWINGS

FIG. 1 is a schematic view of a contaminant removal system comprising one or more component layers constructed in accordance with an exemplary embodiment of the invention.

FIG. 2 is a perspective view of fluid flow conditions within the contaminant removal system of FIG. 1.

### SUMMARY

In one embodiment, the present invention provides a method of making a reverse osmosis membrane, the method comprising the steps of providing a first membrane layer having an active surface and disposing on the active surface of the membrane layer one or more flow modifier structures using a direct-write technique.

In a second embodiment, the present invention provides a method of making a reverse osmosis membrane, said method comprising providing a porous polyethersulfone reverse osmosis membrane having an active surface; and disposing on said active surface one or more flow modifier structures, said disposing being carried out by a direct-write technique.

In a third embodiment, the present invention provides a method of making a membrane stack assembly comprising a membrane layer and a feed carrier layer wherein the active surface of the membrane layer and a first surface of the feed carrier layer comprise flow modifier structures created using a direct-write technique. The membrane layer and the feed carrier layer are then joined to provide a membrane stack assembly.

### DETAILED DESCRIPTION

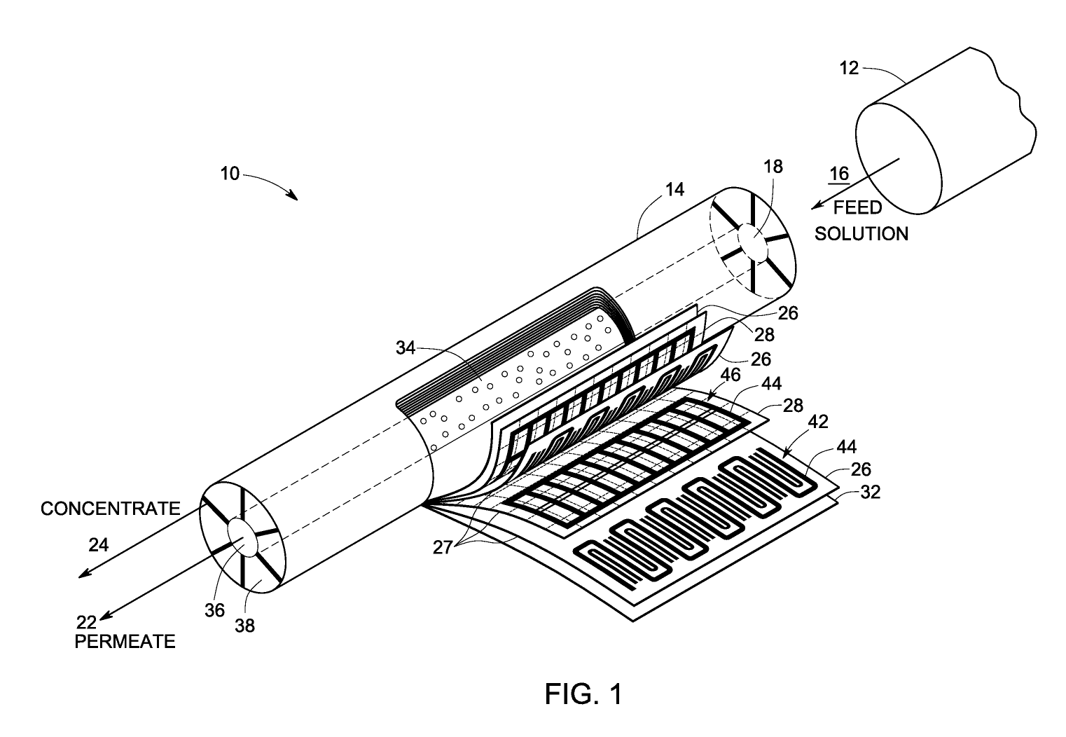

FIG. 1 schematically illustrates a contaminant removal system 10 comprising membrane layer 26 and feed carrier layer components 28 created in accordance with an exemplary embodiment of the invention. The contaminant removal system 10 includes a conduit 12 that carries a feed solution 16 from a source (not shown) to a multi-layer reverse osmosis membrane system 14. The multi-layer reverse osmosis membrane system 14 comprises at least one membrane layer 26 comprising flow modifier structures 42 on the surface of the membrane layer wherein membrane layer is prepared according to the method of the present invention. The flow modifier structures 42 are disposed on the surface of the membrane layer using a direct-write technique. At times herein, the flow modifier structures are said to be “configured by a direct-write technique”, a phrase meaning that the flow modifier structures may be disposed and arranged on the surface of the membrane layer using a direct-write technique.

As will be appreciated by one of ordinary skill in the art, contaminant removal system 10 may be used to separate the feed solution 16 into a stream of permeate 22 and a stream of concentrate 24. For example, sea water may serve as the feed solution 16 and be separated into a permeate 22 containing less salt than the sea water feed solution, and a concentrate 24 containing more salt than the sea water feed solution. Feed solution 16, is supplied via conduit 12 into the multi-layer reverse osmosis membrane system 14 through an inlet 18, sometimes herein referred to as feed surface 18. The multi-layer reverse osmosis membrane system 14 includes at least one reverse osmosis membrane 26 and at least one feed spacer 28, at times herein referred to as feed carrier layer 28. In the embodiment featured in FIG. 1 The multi-layer reverse osmosis membrane system 14 is contained in an outer wrap 32 which may be, for example an outer layer of tape. After entering the multi-layered reverse osmosis membrane system 14, the incoming feed solution 16 flows axially through the multi-layered reverse osmosis membrane system from the feed surface 18 to the concentrate surface 38. A portion of the feed solution 16, the permeate 22, encounters and passes into the membrane layer 26 through which it passes along a spiral path and is collected in a central porous tube 34. The permeate exits the reverse osmosis membrane system 14 via outlet 36. A portion of the feed solution 16 which does not pass into the membrane layer, the concentrate 24, exits the multi-layer reverse osmosis membrane system 14 through an outlet 38, outlet 38 being at times herein referred to as concentrate surface 38.

The term “feed solution”, such as the feed solution 16, is used to describe a liquid containing at least one two components, usually a liquid containing a dissolved solid or liquid, for example water containing salt (NaCl); however, more than two such components may be present in the feed solution, as for example when the feed solution is sea water containing a plurality of dissolved solids. In some applications making use of the membrane layers, feed carrier layers, and membrane stack assemblies provided by the present invention, the feed solution may carry suspended solids of minute size. As used throughout, the term “permeate” is used to identify the component of the feed solution being separated from the “concentrate”, which is a term to identify the remainder of the feed solution after removal of the permeate.

The multi-layer reverse osmosis membrane system 14 of FIG. 1 is shown with a portion of the membrane system in an unwound state to illustrate the multi-layer structure of system 14, and the flow modifier structures and other structural features which may be present on the membrane layer 26 and feed carrier layer 28 (“feed spacer” 28). The direction of flow of a permeate produced during operation of a multi-layer reverse osmosis membrane system 14 is indicated by labeled element 22 and the direction of flow of concentrate is indicated by labeled element 24 (FIG. 1). Membrane layer 26 is typically a flat sheet membrane produced by according to the method of the present invention. Membranes 26 provided by the present invention may be, in certain embodiments, prepared by modification of commercially available membranes known to those of ordinary skill in the art using direct-write techniques as disclosed herein. The feed carrier layer 28, is typically a porous fabric or plastic sheet or web. In one embodiment, the feed carrier layer is disposed between two membrane layers 26 to form a membrane stack assembly comprising four lateral edges. The membrane layers 26 and feed carrier layer 28 of this membrane stack assembly may be sized such that both membrane layers are in contact with and attached to the central porous tube 34. The multi-layer reverse osmosis membrane system 14 is prepared by winding the membrane stack assembly about the central porous tube 34. As shown in the embodiment presented in FIG. 1, the feed carrier layer 28 (“spacers 28”) is disposed between membrane layers 26 such that both surfaces of the feed carrier layer 28 are in contact with a surface (generally the active surface of the membrane layer) of a membrane layer having flow modifier structures 42 disposed upon it. It is useful to note that the feed carrier layer 28 serves to transport the feed solution 16 from the feed surface 18 of the multi-layer reverse osmosis membrane system 14 to the concentrate surface 38 of the multi-layer reverse osmosis membrane system 14, during which transport both permeate 22 and concentrate 24 are produced. The flow modifier structures 42 create turbulence during the passage of the feed solution through the multi-layer reverse osmosis membrane system 14 and act to prevent accretion (build up) of solute at the surface of the membrane layer 26. In addition, the flow modifier structures 42 provide structural support and structural definition to the feed carrier layer membrane layer interface One of ordinary skill in the art will appreciate that tube 34 is made porous so that permeate may pass from a membrane layer in contact with central porous tube 34 into the interior of said tube and from thence to permeate outlet 36.

As noted, the multi-layer reverse osmosis membrane system 14 (FIG. 1) is prepared by winding a membrane stack assembly around the central porous tube 34 such that the membrane layer is in fluid contact with the central porous tube 34 and the feed carrier layer 28 is not in direct contact with the central porous tube 34. Thus, while the feed carrier layer may be said to be in fluid contact with the central porous tube 34, at least one membrane layer is disposed between the feed carrier layer and the central porous tube. At times herein, the arrangement of the membrane layers 26 and feed carrier layer 28 is alternately referred to either as a membrane stack assembly or a composite leaf 27 as shown in FIG. 1. Within composite leaf 27 (or membrane stack assembly 27) the feed carrier layer 28 is sandwiched between two opposing membrane layers 26. To ensure good liquid communication through the perforations into the center of the tube 34, one or more permeate carrier layers may be included in the membrane stack assembly used to prepare the multi-layer reverse osmosis membrane system 14, in which embodiment the permeate carrier layer may be made of a plastic fabric, for example Dacron fabric, a rigid knitted Tricot, or the like. The lateral edges of the membrane stack assembly may be sealed such that the lateral edges of the membrane layers 26 are substantially sealed with respect to contact with feed solution at the feed surface of the multi-layer reverse osmosis membrane system 14 (FIG. 1). Such sealing of the lateral edges of the membrane stack assembly may be carried out such that the feed carrier layer can conduct feed solution from the feed surface into the interior of the multi-layer reverse osmosis membrane system. This sealing operation may be effected conveniently by applying a band of adhesive, for example a curable glue or a cement, along the lateral edge of the membrane stack assembly prior to the winding of the membrane stack assembly around the central porous tube. It should be noted that it is advantages to perform this winding step prior to the sealant being cured so that the membrane layers and feed carrier layer may move relative to one another as required during the winding step. Once the membrane stack assembly has been wound around the central porous tube the sealant may be cured. The completed multi-layer reverse osmosis membrane system 14 typically has a substantially cylindrical form as depicted in FIG. 1, which may be disposed within a pressurizable housing, typically a seamless, substantially rigid, tubular sleeve. Although the central tube 34 may extend out beyond one or both ends of the multi-layer reverse osmosis membrane system 14, in the illustrated embodiment (FIG. 1) it is shown as being flush with the ends of the wound membrane stack assembly.

A variety of different membranes 26 comprising surface flow modifier structures made using the method of the present invention are useful in the preparation of multi-layer reverse osmosis membrane systems 14. In one instance, the membrane 26 may be a thin-film composite membrane comprising flow modifier structures disposed on the active surface of said membrane using a direct-write technique. In one embodiment, the membrane 26 prepared according to the method of the present invention may be a thin-film composite membrane, such as, for example, an S series thin-film composite membrane. It is desirable that the surface flow modifier structures on the membrane surface be adapted to withstand the desired process parameters associated with the preparation and use of the multi-layer reverse osmosis membrane system 14. Both anisotropic (asymmetric) membranes having a single or double barrier layer (skin) and isotropic membranes may be used in the preparation of the membranes provided by the method of the present invention. The membrane layer used according to the method of the present invention may in certain embodiments comprise a single polymeric material or a plurality of polymeric materials. Further, the membranes used according to the method of the present invention may be laminated or formed of a composite structure wherein a charged or uncharged thin barrier coating or film is formed over a thicker substrate film, the latter being either porous or non-porous (diffusional). Polymeric materials suitable for use in such membranes may range from highly stable hydrophobic materials such as polyvinylidene fluoride, polysulfones, modacrylic copolymers polychloroethers and like polymeric materials frequently used for ultrafiltration, microfiltration and gas filtration applications and as substrates for reverse osmosis composites. Other materials suitable for use in the membrane layer include hydrophilic polymers such as cellulose acetate and various polyamines.

In one embodiment, the membrane used according to the method of the present invention may be of the asymmetric type, such as cellulose acetate membranes wherein a thin, active, dense layer is formed at a first surface of a solvent cast polymeric material by selective evaporation or like technique. The remainder of the membrane throughout and extending to a second surface is of a much more porous composition which tends to integrally support the dense active surface layer which exhibits the semipermeable characteristics.

Alternatively, membranes used according to the method of the present invention may be prepared wherein a dense, active surface layer is formed of a different material from a non-active (passive) supporting layer. Such membranes may be made by a variety of suitable methods known to those of ordinary skill in the art. In one embodiment, the membrane layer used according to the method of the present invention comprises a dense active layer formed on the surface of a porous substrate by an interfacial condensation reaction. Thus, a thin film of a first reactant (for example a diamine) dispersed in an aqueous phase may be disposed on the surface of the porous substrate and subsequently a second reactant (for example a polyacid chloride) in a water-immiscible organic solvent is layered onto the surface of the porous substrate and an interfacial polymerization reaction is carried out on the surface of the porous substrate to create a thin, dense, polymeric surface coating, such as a polyamide having the desired semipermeable characteristics. The porous, less dense, supporting layer adjacent to the surface on which the interfacial condensation reaction takes place may be made of any suitable polymeric material, such as a porous polyethersulfone, having the desired pore size to adequately support the thin film of the interfacially prepared surface layer without creating features leading to undesirably high pressure drops across it during operation. In yet another instance, membrane layers suitable for use according to the method of the present invention may be made by solvent casting techniques. For example, suitable porous membrane layers comprising polyethersulfone may be prepared by solvent casting techniques known to one of ordinary skill in the art.

As noted, in another aspect, the present invention provides a method of making a membrane stack assembly, the membrane stack assembly comprising a membrane layer having surface flow modifier structures and a feed carrier layer also comprising flow modifier structures, said flow modifier structures having been prepared using a direct-write technique. The method provided by the present invention comprises providing a membrane layer having an active surface; disposing on said active surface one or more flow modifier structures, said disposing being carried out by a direct-write technique; providing a feed carrier layer having a first surface; disposing on said first surface one or more flow modifier structures, said disposing being carried out by a direct-write technique; and joining said membrane layer to said feed carrier to provide a membrane stack assembly having a plurality of lateral edges. In one embodiment, the membrane stack assembly provided by the method of the present invention comprises four such lateral edges. Such membrane stack assemblies may be used to prepare multi-layer reverse osmosis membrane systems such as that illustrated in FIG. 1 of this disclosure. When incorporated into a multi-layer reverse osmosis membrane system such as 14, the feed carrier layer comprising one or more flow modifier structures 42 and provided by the method of the present invention using a direct-write technique provides flow channels or otherwise enhances the flow of a feed solution 16 through the feed carrier layer 28 in contact with membrane layer 26 (See FIG. 1). The membrane stack assemblies provided by the method of the present invention are sufficiently flexible to allow winding of the membrane stack assembly about a central porous tube 34. As elaborated earlier, in one embodiment, the function of the feed carrier layer 28 is to provide a space between opposing active surfaces of the membrane layers 26 so that the feed solution 16 being introduced into a multi-layer reverse osmosis membrane system 14 is transported efficiently from the feed surface by the feed carrier layer into the interior of the multi-layer reverse osmosis membrane system.

A variety of materials are suitable for use as the feed carrier according to the method of the present invention. Synthetic fiber materials may be used as the feed carrier layer, such as those made from thermoplastic polymers, including polyethylene and polypropylene. In another embodiment of the invention, woven screening material may be used as the feed carrier layer. In another embodiment of the invention, polypropylene netting or screening material may be used as the feed carrier layer.

As noted, the present invention provides methods for making reverse osmosis membranes, and methods for making membrane stack assemblies wherein a direct-write technique is employed to create flow modifier structures on the surface of a membrane layer or on the surface of both a membrane layer and a feed carrier layer. As illustrated in FIG. 1, such membrane layers and membrane stack assemblies are useful in the preparation of multi-layer reverse osmosis membrane systems 14 wherein a membrane layer 26 and a feed carrier layer 28 comprise surface flow modifier structures 42. The flow modifier structures 42 may be formed by depositing surface modifying agents 44 on the surface of the membrane 26. The surface modifying agent 44 may serve as the precursor to a flow modifier structure or the flow modifier structure itself. In addition, the surface modifying agent 44 may serve a function other than flow modification. For example, the surface modifying agent may serve as a precursor to a flexible structure 46 which may protect the structural integrity of the flow modifier structures during preparation and operation of the multi-layer reverse osmosis membrane system 14.

Although flow modifier structures 42 may be formed in a variety of ways, it has been found especially advantageous to prepare such flow modifier structures using a direct-write technique. In one embodiment of the invention, the flow modifier structures 42 may include sharp faces. In another embodiment of the invention, the flow modifier structures 42 may include a flexible structure. In another embodiment of the invention, the flow modifier structures 42 may be formed by embedding silicon on the surface of the membrane layer. In another embodiment, the flow modifier structures 42 on the surface of a membrane layer and a feed carrier layer in a membrane stack assembly may possess interactive, or complimentary geometries. In yet another embodiment, the method of the present invention, may be used to prepare feed carrier layers comprising flexible structures (shown in FIG. 1 element 46 disposed on feed carrier layer 28). Flexible structures may be prepared by depositing surface modifying agents 44 on the surface of, for example, the feed carrier layer which is subsequently elaborated to a flexible structure.

Various materials may be used as surface modifying agents 44. In one embodiment of the invention, the surface modifying agents 44 may include polymer-based low viscosity materials in liquid or semi-liquid form. In another embodiment of the invention the surface modifying agents 44 may be ceramic materials in liquid or semi-liquid form. In yet another embodiment of the invention the surface modifying agents 44 may be metal-based materials in liquid or semi-liquid form.

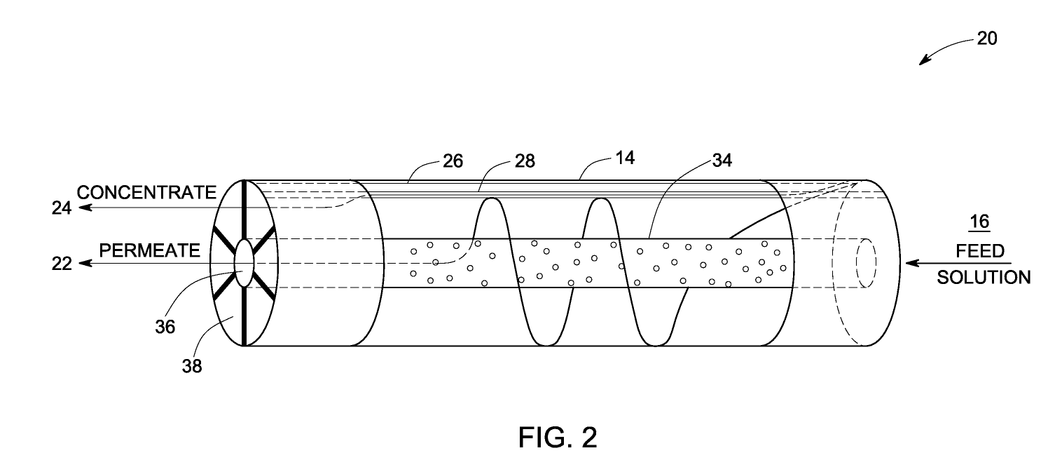

FIG. 2, like FIG. 1, is illustrative of the utility of the membrane layers, feed carrier layers, and membrane stack assemblies provided by the method of the present invention. Thus FIG. 2 illustrates the spiral flow of permeate 22 through a multi-layer reverse osmosis membrane system 14 comprised in a contaminant removal system 20 during operation. The feed solution 16 flows contacts feed surface 18 of the multi-layered reverse osmosis membrane system 14. A portion (the permeate) of the feed solution 16 passes into the interior of the membrane layer 26. That portion of the feed solution which does not enter into the membrane layer is referred to as concentrate and exits the multi-layer reverse osmosis membrane system 14 at concentrate surface 38. The permeate 22 flows in a spiral path (idealized in FIG. 2) inward to the central porous tube 34 through the membrane layer.

Still referring to FIG. 1 and FIG. 2, in one embodiment, permeation of a portion of the feed solution 16 through the membrane 26 along the feed-concentrate flow path causes a gradual reduction feed velocity in a fixed-dimension channel results in reduced the downstream permeation efficiency. Design modifications of the membrane layer and feed carrier layer components of the multi-layered reverse osmosis membrane system 14 may reduce such feed velocity changes. In one embodiment of the invention, some design changes may include using tapered feed carrier layers 28 to progressively reduce the distance between membranes 26 along the length of the multi-layer reverse osmosis membrane system 14, thereby constricting the downstream flow path and increasing fluid velocity.

The membrane layer, feed carrier layers and membrane stack assemblies provided by the method of the present invention may be used in a variety of ways but are particularly useful as components of multi-layer reverse osmosis membrane systems 14. Embodiments of the invention enable the removal of contaminants from a feed solution. It will be appreciated by those skilled in the art that although the description above relates in certain embodiments to industrial feed solutions, embodiments of the invention are equally applicable to other low-pressure applications such as ultrafiltration and microfiltration, which are widespread and difficult to implement with high conversion efficiency at low cost.

The principle of this invention is useful in any spiral wound membrane device employing flat sheet membrane for reverse osmosis, ultrafiltration, membrane softening, microfiltration, and gas separation. Embodiments of the invention may allow a single element (for example a multi-layer reverse osmosis membrane system 14) ranging in length from about 12-60 inches to operate under turbulent or chopped laminar flow conditions at recoveries up to 90% while maintaining boundary layer conditions similar to current brine staged spiral system designs using 12 to 18 elements in series. Said another way, the degree of conversion/recovery of the feed stream is less dependent on the length of a module, but rather depends more upon the topography and structure of the flow modifier structures present on the membrane layer surface, or membrane layer and feed carrier layer surfaces, which affect the overall performance of the unit.

As mentioned above, the present invention provides membranes and membrane stack assemblies comprising surface flow modifier structures created using one or more direct direct-write techniques. Direct-write techniques are known in the art and described in many references. An instructive text is also available: “Direct-Write Technologies for Rapid Prototyping Applications”, edited by A. Pique and D. B. Chrisey, Academic Press, 2002. As used herein, a direct-write technique is a process in which a liquid, liquid suspension, or paste (higher material loading) is deposited onto a surface by ejecting the material through an orifice toward the surface, using a suitable direct-write tool. Usually, the tool itself does not make substantial contact with the surface. The direct-write tool is preferably controllable over an x-y grid relative to the printed surface (i.e., either or both the substrate and the device may move).

In general, the deposition materials for direct-write techniques can include a wide variety of metal, ceramic, or polymeric powders. In one embodiment, the deposition material is a ceramic powder. In another embodiment, the deposition material is a polymeric powder. In yet another embodiment, the deposition material is a metal powder. In one embodiment, the powder is uniformly distributed in a solvent, forming a slurry (also referred to as an “ink”). Various additives may also be present. For example, different types of surfactants can be added to impart suitable flow characteristics to the slurry. Moreover, binders such as starch or cellulose are also frequently used to enhance the integrity of the deposited material, prior to a subsequent heat treatment. The slurry can have a range of viscosities, e.g., from water to tar, depending on various factors. Those factors include the type of direct-write technique employed; and the types of features being formed, e.g., their size, shape, and required integrity. The slurry or ink is applied directly onto the membrane layer provided or the feed carrier layer provided, using an automated slurry handling system. Usually, a CAD/CAM interface is employed to program a desired pattern for the deposition.

Many of the general details regarding slurry formation are known in the art and need not be described extensively here. Reference is made to various sources for ceramics processing, such as the “Kirk-Othmer Encyclopedia of Chemical Technology”, 4th Edition, Vol. 5, pp. 610-613”. Moreover, the direct-write text mentioned above (Pique and Chrisey) describes many of the desirable characteristics for direct-write ink and paste formulations. In one embodiment, the direct-write technique comprises patterning a ceramic material as positive features on the membrane layer active surface. In one embodiment, the direct-write technique comprises patterning a ceramic material as positive features on the active surface of a reverse osmosis membrane.

Positive features which may be created on the surface of a membrane layer or a feed carrier layer may comprise any suitable organic, inorganic, or composite material which may be applied using a direct-write technique. In one embodiment, the positive features comprising the flow modifier structures is selected from the group consisting of diamonds, cones, hemispheres, hemispherical sections, circular pins, elongate hexahedrons, elongate semi-cylinders, and combinations thereof.

In one embodiment, the membrane layer provided by the method of the present invention comprises irregularly shaped flow modifier structures. In another embodiment, the membrane layer provided by the present invention comprises regularly shaped flow modifier structures. In yet another embodiment, the present invention provides a feed carrier layer comprising irregularly shaped flow modifier structures. In yet another embodiment, the present invention provides a feed carrier layer comprising regularly shaped flow modifier structures. In one embodiment, the method of the present invention provides a membrane stack assembly comprising a membrane layer

In brief, the slurry is preferably well-dispersed and free of air bubbles and foaming. It typically has a good rheological properties adjusted in accordance with the requirements for the particular direct-write technique to be employed. (For example, a ceramic slurry is often provided with the consistency of toothpaste when various pen techniques are used, as described below). Preferably, the solid particle settling rate in the slurry should be as low as possible. The slurry should also be chemically stable. Furthermore, when dry, the deposited ceramic material should retain its shape, and possess sufficient strength for subsequent steps, e.g., finishing and handling before firing.

A wide variety of additives can be present in the slurry, to provide the necessary characteristics. Non-limiting examples (in addition to the binders and surfactants mentioned above) include: thickening agents, dispersants, deflocculants, anti-settling agents, plasticizers, emollients, lubricants, surfactants and anti-foam agents. Those skilled in the art will be able to select the most appropriate level of any additive used, without undue experimentation. The slurry can be prepared by any conventional mixing technique. Non-limiting examples include the use of high-speed blenders, ribbon blenders, rotating canisters, and shear mixtures, e.g., a roll mill.

As alluded to previously, the direct-write techniques which can be used according to the method of the present invention are known in the art. For example, the thermal spray techniques may be derived from conventional processes, as described in the Pique/Chrisey text (e.g., pp. 265-293). Non-limiting examples deposition techniques which may be adapted for use as direct-write techniques according to the method provided by the present invention include high velocity oxy-fuel (HVOF) techniques, and plasma processes, such as vacuum plasma deposition (VPS). HVOF is a continuous combustion process in which the powder is injected into the jet stream of a spray gun at very high speeds. Those of ordinary skill in the art are familiar with various HVOF details, such as the selection of primary gasses, secondary gasses (if used), and cooling gasses; gas flow rates; power levels; coating particle size, and the like.

In a typical plasma process, a generic DC (direct current) thermal plasma torch is employed, providing a stable electric arc between a cathode and an annular, water-cooled copper anode. A plasma gas (often argon or another inert gas) is introduced at the back of the spray gun interior. The gas swirls in a vortex, and then exits out of the front of the anode nozzle. The electric arc from the cathode to the anode completes the electric circuit, forming an exiting plasma flame.

As those familiar with plasma spray technology understand, plasma temperatures can be very high, e.g., 15,000 K for a conventional DC torch operating at 40 kW. In one embodiment, a ceramic material being deposited on a membrane layer substrate is supplied in powder form. The powder is introduced into the plasma flame. The powder particles are accelerated and melted in the flame, on a high-speed path to the substrate, where they impact and undergo rapid solidification. Those skilled in the art are familiar with variations in the general plasma spray process, and familiar with techniques for adapting the process to a variety of deposition materials. In the present instance, the plasma processes and other thermal spray techniques are modified to provide a computer-interface.

Another suitable technique which may be adapted for use as a direct-write technique according to the method of the present invention is Laser Chemical Vapor Deposition (LCVD), also described in the Pique/Chrisey text. LCVD is a thermal technique used in creating films. In brief, a laser is employed as an activator of a precursor for a ceramic material that is photolyzed, pyrolyzed, or vibrationally/rotationally excited. The technique can be used to form complex structures on a membrane layer or feed carrier layer substrate, by “mass-addition”. The material deposition can be carried out under computerized motion control, as in other direct-write processes.

Another very common direct-write process is based on ink-jet techniques. These techniques are described extensively in the Pique/Chrisey text (e.g., Chapter 7), and in many other references, e.g., the “Kirk-Othmer Encyclopedia of Chemical Technology”, 4th Edition (1996), Vol. 20, pp. 112-119. Various ink jet systems can be employed, e.g., continuous mode systems and demand-mode (e.g., impulse) systems. Within the latter category, there are various types of impulse systems as well, e.g., piezoelectric systems and thermal impulse systems. The electronic control mechanisms for ink jet systems are also well-understood in the art. Various computer-control systems can be employed, e.g., using a CAD/CAM interface in which the desired pattern of deposition is programmed.

Those skilled in the art are familiar with the requirements for ink compositions, which can usually be aqueous or solvent-based. In addition to some of the additives mentioned above, ink jet compositions may contain other ingredients, which are somewhat particular to this deposition method. For example, humectants and selected co-solvents may be use to inhibit drying of ink in the nozzles. The composition of the ceramic slurries used according to this disclosure can be readily adjusted to be compatible with ink jet deposition.

Yet another direct-write process, which can be used for this invention, is laser-guided direct writing (LGDW). In a typical process of this type, a stream of deposition particles is produced, as described in the Pique/Chrisey text (e.g., pp. 10 and 646-648) which text is incorporated herein by reference in its entirety for all purposes. The particles are constrained by a laser beam, and directed onto a selected region of the substrate. The particles often originate as suspensions, e.g., a suspension in water. In some instances, ultrasonic atomization is used to spread the particles in the atmosphere, for contact with the laser beam.

Laser particle guidance systems and related details are described in commonly known art. A laser particle guidance system typically includes various positioning mechanisms, which are computer-driven to direct the pattern of deposition. Some of the LGDW systems are commercially available from Optomec Design Company, Albuquerque, N.M.

The “MAPLE” technique is another example of a direct-write process suitable for use according to the method of the present invention. (The acronym “MAPLE” corresponds to “matrix assisted pulsed laser evaporation”). The MAPLE technique is described in considerable detail in the Pique/Chrisey text (e.g., pp. 138-139; 521 et seq.).

In brief, MAPLE uses a focused ultraviolet laser pulse to transfer material from a coating on a carrier, onto a substrate. In one type of MAPLE system, the laser impacts the material to be transferred from the back at the carrier-material interface, through the carrier (which is usually transparent). The material is designed to absorb the laser energy, causing local evaporation at the interface. Discrete “packets” of the deposition material are thus propelled toward the substrate, according to a computer-controlled pattern. Using a sequence of laser pulses while moving one or both of the carrier and the substrate, a desired pattern can be directly written.

Those skilled in the art will be able to adjust the characteristics (e.g., particle size and rheology) of the ceramic composition used herein, to be compatible with the MAPLE process. Various other process parameters can also be adjusted by those familiar with MAPLE. Examples of the parameters include incident beam energy, pulsed laser rate, and the like.

Pen-dispensing systems represent another class of direct-write techniques, and they are often preferred for the present invention. The systems often use automated syringes, and are sometimes generally referred to as “micropen printing” processes. The referenced Pique/Chrisey text provides a general description of these systems (e.g., chapter 8); they are also mentioned in the above-referenced Hampden-Smith patent. Some of the process factors mentioned above are relevant here as well, such as the rheology of the printing paste or ink, as well as its wetting and adhesion characteristics. Commercial pen-dispensing systems are available from various sources. For example, the Micropen® tool is available from Ohmcraft, Inc., of Honeoye Falls, N.Y. The Dotliner® dispensing system is available from Manncorp, Huntingdon Valley, Pa.

In one embodiment, the direct-write technique is a pen-dispensing technique carried out with a robotic pen comprising (i) a computer-controlled movable stage for mounting the first reverse osmosis membrane for rotation and orthogonal translation, and an elevator for translation from the stage; (ii) a pen tip rotatably mounted to the elevator; and (iii) a dispenser joined in flow communication with the pen tip, for ejecting a stream of material onto at least one surface of the multi-layered reverse osmosis membrane.

In an additional embodiment, the movable stage further comprises a first table for translating the reverse osmosis membrane in a first linear axis; a second table for translating the reverse osmosis membrane in a second linear axis orthogonal to the first linear axis; and a spindle for rotating the reverse osmosis membrane in a first rotary axis; wherein the pen tip is mounted to the elevator for translation in a third linear axis orthogonal to the first and second linear axes, and for rotation in a second rotary axis coordinated with the first rotary axis, for orienting the pen tip relative to the reverse osmosis membrane.

While the invention has been described in detail in connection with only a limited number of embodiments, it should be readily understood that the invention is not limited to such disclosed embodiments. Rather, the invention may be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed:

1. A method of making a reverse osmosis membrane, said method comprising:
providing a first membrane layer having an active surface; and
disposing on said active surface one or more flow modifier structures, said disposing being carried out by a direct-write technique.

2. The method according to claim 1, wherein the direct-write technique is selected from the group consisting of thermal spray, laser CVD, ink jet, laser particle guidance, matrix assisted pulsed laser evaporation (MAPLE), pen dispensing techniques, and combinations of any of the foregoing.

3. The method according to claim 1, wherein the direct-write technique is a plasma spray process.

4. The method according to claim 1, wherein the direct-write technique is a high velocity oxy-fuel (HVOF) process.

5. The method according to claim 1, wherein the direct-write technique is a pen-dispensing technique carried out with a robotic pen comprising (i) a computer-controlled movable stage for mounting the first reverse osmosis membrane for rotation and orthogonal translation, and an elevator for translation from the stage; (ii) a pen tip rotatably mounted to the elevator; and (iii) a dispenser joined in flow communication with the pen tip, for ejecting a stream of material onto at least one surface of the multi-layered reverse osmosis membrane.

6. The method according to claim 5, wherein the movable stage further comprises a first table for translating the reverse osmosis membrane in a first linear axis; a second table for translating the reverse osmosis membrane in a second linear axis orthogonal to the first linear axis; and a spindle for rotating the reverse osmosis membrane in a first rotary axis; wherein the pen tip is mounted to the elevator for translation in a third linear axis orthogonal to the first and second linear axes, and for rotation in a second rotary axis coordinated with the first rotary axis, for orienting the pen tip relative to the reverse osmosis membrane.

7. The method according to claim 1, wherein the direct-write technique comprises patterning a ceramic material as positive features on the membrane layer active surface.

8. The method according to claim 7, wherein the positive features have a shape selected from the group consisting of diamonds, cones, hemispheres, hemispherical sections, circular pins, elongate hexahedrons, elongate semi-cylinders, and combinations thereof.

9. The method according to claim 1, wherein at least one of said flow modifier structures is irregularly shaped.

10. A method of making a reverse osmosis membrane, said method comprising:
providing a porous polyethersulfone reverse osmosis membrane having an active surface; and
disposing on said active surface one or more flow modifier structures, said disposing being carried out by a direct-write technique.

11. The method of claim 10, wherein the direct-write technique is selected from the group consisting of thermal spray, laser CVD, ink jet, laser particle guidance, matrix assisted pulsed laser evaporation (MAPLE), pen dispensing techniques, and combinations of any of the foregoing.

12. The method according to claim 10, wherein the direct-write technique is a plasma spray process.

13. The method according to claim 10, wherein the direct-write technique is a high velocity oxy-fuel (HVOF) process.

14. The method according to claim 10, wherein the direct-write technique comprises patterning a ceramic material as positive features on the reverse osmosis membrane surface.

15. The method of claim 14, wherein the positive features are in a shape selected from the group consisting of diamonds, cones, hemispheres, hemispherical sections, circular pins, elongate hexahedrons, elongate semi-cylinders, and combinations thereof.

16. A method of making a membrane stack assembly, said method comprising:
providing a membrane layer having an active surface;
disposing on said active surface one or more flow modifier structures, said disposing being carried out by a direct-write technique;
providing a feed carrier layer having a first surface;
disposing on said first surface one or more flow modifier structures, said disposing being carried out by a direct-write technique; and
joining said membrane layer to said feed carrier to provide a membrane stack assembly having four lateral edges.

17. The method according to claim 16, wherein said joining comprises sealing one or more of the lateral edges.

18. The method according to claim 17, wherein said sealing comprises applying a cement to the lateral edge of the membrane layer.

19. The method according to claim 16, wherein said feed carrier layer has a thickness which is tapered.

20. The method according to claim 16, wherein said membrane layer comprises a porous polyethersulfone.
